(19) United States
(12) Patent Application Publication
(10) Pub. No.: US 2004/0013936 A1
(43) Pub. Date: Jan. 22, 2004

(54) Vent cap

(76) Inventor: James H. Barrett Jr, Gataw Island, SC (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/311,659

(22) PCT Filed: Jun. 18, 2001
(86) PCT No.: PCT/US01/19498

(51) Int. Cl. H01M 2/36; H01M 2/12

(52) U.S. Cl. 429/71; 429/72; 429/79; 429/82; 429/83

(57) ABSTRACT

A vent cap (10) for a battery having a centrally disposed cavity (22) to militate against contamination of battery components from impurities contained in the ambient air and also including a plurality of alternating partitions (26) which creates a condensation medium for the deposit of droplets of electrolyte carried by gases venting from the battery.

### CROSS-REFERENCE TO RELATED APPLICATION

This application claims the benefit of U.S. provisional patent application Serial No. 60/212,763, filed Jun. 20, 2000.

### FIELD OF THE INVENTION

The invention relates to a vent cap and more particularly to a vent cap for a battery including a labyrinth structure through which gas from the battery is caused to pass while droplets of electrolyte carried by the gases from the battery are caused to condense and coalesce on the labyrinth structure.

### BACKGROUND OF THE INVENTION

Wet cell electric storage batteries such as those used in industrial traction batteries typically include a battery cover having a vent opening providing communication with a battery cell. The vent opening facilitates access to the battery cell for initial filling with electrolyte and permitting the fluid level to be checked and corrected occasionally during the life of the battery. The vent opening also permits the controlled venting of gases generated during the discharging and the recharging of the battery.

Prior art battery vent caps incorporate a vertical flow configuration for directing venting gases from a battery. An inherent problem with the vertical flow configuration is the possibility of contamination of the battery fluid with foreign matter such as oil, neutralizing agents used in washing the battery, or other substances which could settle on the vent cap surfaces. Additionally, the contaminants can restrict or block the gas vent. A restricted or blocked gas vent can result in a dangerous pressure buildup within the battery cell or element jar creating the possibility of a ruptured cell or cover separation.

Other problems inherent in prior art vent cap designs include the loss of electrolyte from the battery in the vent gas and the use of structures having numerous parts.

It would be desirable to produce a vent cap which militates against entry of contaminants into an associated battery, militates against loss of electrolyte from the battery, and minimizes vertical gas flow from the battery.

### SUMMARY OF THE INVENTION

Consistent and consonant with the present invention, a vent cap for a battery cell cover which militates against entry of contaminants into an associated battery, militates against loss of electrolyte from the battery, and minimizes vertical gas flow from the battery has surprisingly been discovered. The vent cap for a battery cell cover having an aperture formed therein comprises: a main body having a centrally disposed cavity, the main body including an inlet and an outlet, the inlet providing communication between an associated battery cell and the cavity and the outlet providing communication between the cavity and ambient air, and a plurality of spaced apart partitions defining a flow path, the partitions disposed in the cavity of the main body.

### BRIEF DESCRIPTION OF THE DRAWINGS

The above, as well as other objects, features, and advantages of the present invention will be understood from the detailed description of the preferred embodiments of the present invention with reference to the accompanying drawings, in which:

FIG. 1 is a bottom perspective view of a vent cap incorporating the features of the invention;

FIG. 2 is a bottom perspective view of an alternate embodiment of the vent cap illustrated in FIG. 1; and

FIG. 3 is a perspective view of the vent cap illustrated in FIG. 1 showing the vent cap installed in the open position on an associated battery cell cover.

### DETAILED DESCRIPTION OF THE PREFERRED EMBODIMENT

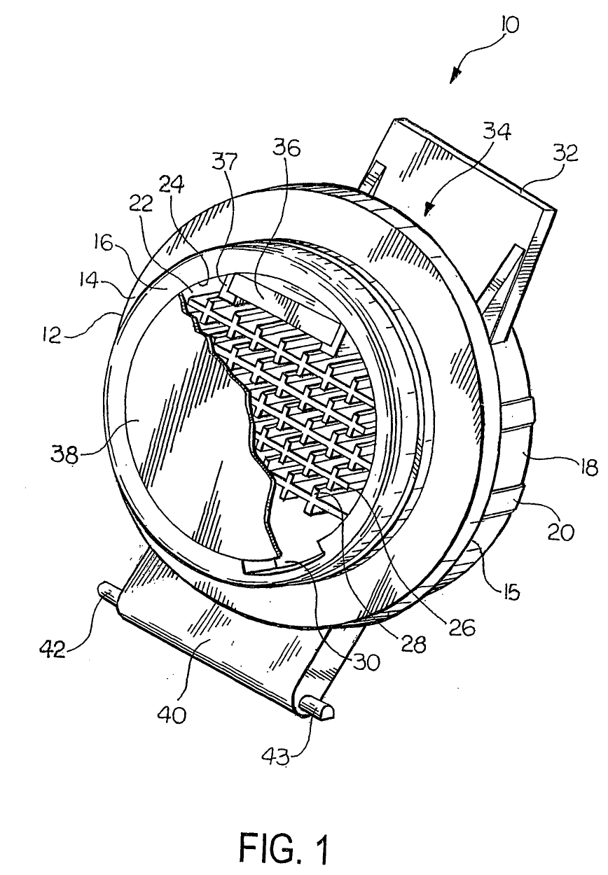

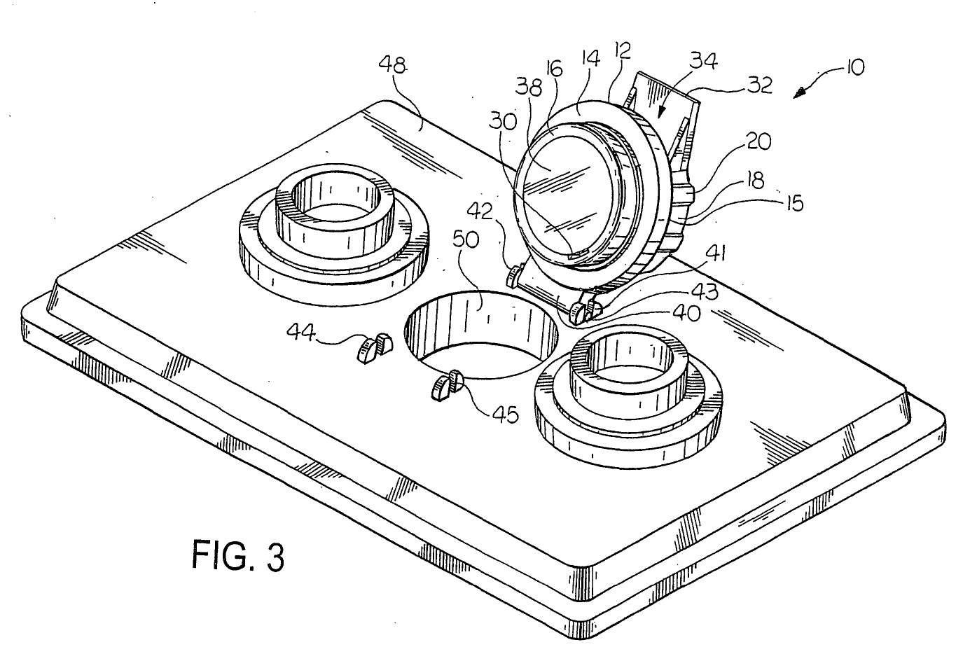

Referring now to the drawings, and particularly FIGS. 1 and 3, there is shown generally at 10 a vent cap incorporating the features of the invention. The vent cap 10 includes an annular main body 12. The main body 12 has an annular outer wall with a first lower surface 14 and a cooperating second upper surface 15. An annular lip 16 extends outwardly from the first surface 14. The second surface 15 has a generally cylindrical head portion 18 which extends outwardly therefrom, as illustrated in FIG. 3. A plurality of spaced apart protuberances 20 are formed on an outer wall of the head portion 18.

The main body 12 includes a centrally disposed cavity 22 formed by an inner cylindrical wall 24 of the main body 12. A plurality of alternating partitions 26 form a flow path in the cavity 22 for vent gases from an associated battery. Each of the partitions 26 includes a plurality of spaced apart baffles 28 which cooperate to form a labyrinth to maximize the overall length of the flow path through the partitions 26. In the embodiment shown, the baffles 28 of one partition 26 are interdigitated between the baffles 28 of an adjacent partition 26. The partitions 26 and baffles 28 provide a large surface area for condensation of conderisables such as electrolytes, for example, present in the vent gases from the battery. It is understood that the partitions 26 can either be formed separately and inserted into the cavity 22 or integrally formed with the main body 12.

An inlet 30 is formed in the inner cylindrical wall 24 and provides fluid communication between a cell of the battery and the cavity 22. An outwardly and laterally extending lift tab 32 is formed adjacent an outlet 34. The outlet 34 is formed in the head portion 18 of the main body 12 and provides fluid communication between the cavity 22 and the ambient air. A hydrophobic barrier 36 is disposed within the cavity 22 to cover the outlet 34. A pair of spaced apart guide walls 37 are adapted to receive, position, and hold the hydrophobic barrier 36 in place against the inner cylindrical wall 24. The hydrophobic barrier 36 is produced from any conventional material antagonistic to water such as sintered polypropylene, for example. Although a planar hydrophobic barrier 36 is illustrated, it is understood that a barrier having a different shape can be used such as curved to conform to the inner cylindrical wall 24, for example. A removable cover 38 is adapted to enclose the cavity 22, while leaving the inlet 30 open as illustrated in FIGS. 1 and 3.

A hinge section or platform 40 extends outwardly and laterally from the main body 12 diametrically opposite the lift tab 32 and includes a pair of oppositely extending protuberances 42 and 43. The protuberances 42 and 43 are adapted to be received with respective upwardly projecting pin receiving detents 44 and 45 typically formed integral with a battery cell cover 48. The protuberances 42, 43 and the respective detents 44, 45 cooperate to form a hinge between the vent cap 10 and the battery cell cover 48. It is understood that other hinges can be used.

In operation, the vent cap 10 is installed on the battery cell cover 48 by snapping the protuberances 42, 43 into the slots formed on the respective detents 44, 45. The vent cap 10 is pivoted about the protuberances 42, 43 until the lip 16 of the main body 12 is received in an aperture 50 formed in the battery cell cover 48.

The vent cap 10 functions to condense electrolyte from gases being vented from the battery. The vent gases enter the inlet 30 and are directed through the flow path in the labyrinth formed by the partitions 26 and baffles 28. The large amount of surface area created by the unique labyrinth provides an efficient condensing surface which causes electrolyte droplets to condense out of the vent gases and drain back into the battery, thereby minimizing required electrolyte balancing. The removal of the electrolyte from the vent gases also helps keep the top surfaces of the battery clean and eliminates dangerous and irritating fumes. Other liquid and solid contaminants present in the vent gases will also be removed. The vent gas then travels through the hydrophobic barrier 36 and out of the vent cap 10 through the outlet 34.

The outlet 34 is located directly below and protected by the lift tab 32. The outlet 34 is thus protected by the lift tab 32 against contamination and foreign matter present on the top of the battery.

The entire vent cap 10 may be opened to permit easy inspection of water levels by grasping the lift tab 32 and pulling upward and pivoting the vent cap 10 about the protuberances 42, 43. A watering device such as a hose, for example, may be easily inserted into the battery for filling. Prior art vent caps require that the watering device be directed through the vent cap assembly when filling the battery cells which is often difficult and hinders visual observation of the water level within the battery. After inspection or filling of the battery cell, the vent cap 10 is pivoted to be reinserted in the aperture 50 of the battery cell cover 48.

Additionally, the unique labyrinth structure of the present invention provides flame and spark protections. The structure serves as a flame and spark arrestor and militates against ignition of fumes which escape from the battery by sparks or flames.

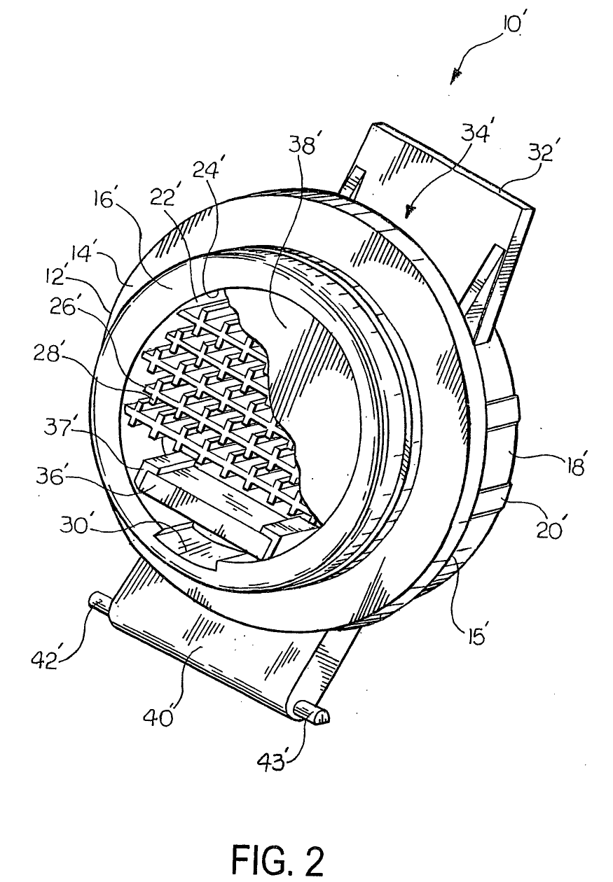

A second embodiment of the present invention is illustrated in FIG. 2, wherein prime numerals are utilized to describe parts which are the same as illustrated in FIGS. 1 and 3. The hydrophobic barrier 36′ of the second embodiment is disposed within the cavity 22′ to cover the inlet 30′.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A vent cap for an aperture in a battery cell cover, the vent cap comprising:
a main body having a centrally disposed cavity, said main body including an inlet and an outlet, the inlet providing communication between an associated battery cell and the cavity and the outlet providing communication between the cavity and ambient air; and
a plurality of spaced apart partitions defining a flow path, said partitions disposed in the cavity of said main body.

2. The vent cap according to claim 1, wherein each of said partitions includes a plurality of baffles extending therefrom to redirect the flow path defined by said partitions.

3. The vent cap according to claim 2, wherein the baffles of said partitions are interdigitated between the baffles of adjacent partitions.

4. The vent cap according to claim 1, wherein said partitions are removable.

5. The vent cap according to claim 1, wherein said partitions are formed as an integral part of said main body.

6. The vent cap according to claim 1, including a hinge section disposed on said main body for pivotally connecting said main body to a battery cell cover.

7. The vent cap according to claim 1, including a hydrophobic barrier covering the outlet of said main body.

8. The vent cap according to claim 1, including a hydrophobic barrier covering the inlet of said main body.

9. The vent cap according to claim 1, wherein the cavity of said main body is enclosed by a removable cover.

10. A vent cap for a battery cell cover having an aperture formed therein, the vent cap comprising:
a main body having a centrally disposed cavity, said main body including an inlet and an outlet, the inlet providing communication between an associated battery cell and the cavity and the outlet providing communication between the cavity and ambient air;
a plurality of spaced apart partitions defining a flow path, said partitions disposed in the cavity of said main body; and
a hydrophobic barrier covering the outlet of said main body.

11. The vent cap according to claim 10, wherein each of said partitions includes a plurality of baffles extending therefrom to redirect the flow path defined by said partitions.

12. The vent cap according to claim 11, wherein the baffles of said partitions are interdigitated between the baffles of adjacent partitions.

13. The vent cap according to claim 10, wherein said partitions are removable.

14. The vent cap according to claim 10, wherein said partitions are formed as an integral part of said main body.

15. The vent cap according to claim 10, including a hinge section disposed on said main body for pivotally connecting said main body to a battery cell cover.

16. The vent cap according to claim 10, wherein the cavity of said main body is enclosed by a removable cover.

17. A battery having a vent cap comprising:
an electric storage battery including a plurality of cells and a battery cell cover, the battery cell cover having at least one aperture formed therein;
a vent cap removably disposed in the aperture of the battery cell cover, said vent cap having a centrally disposed cavity and including an inlet and an outlet, the inlet providing communication between one of said plurality of cells and the cavity and the outlet providing communication between the cavity and ambient air;
a plurality of spaced apart partitions defining a flow path, said partitions disposed in the cavity of said vent cap, each of said partitions includes a plurality of baffles to redirect the flow path defined by said partitions;
a hydrophobic barrier covering the outlet of said main body; and
a hinge pivotally connecting said vent cap to the battery cell cover of said battery.

18. The invention defined in claim 17, wherein the baffles of said partitions are interdigitated between the baffles of adjacent partitions.

19. The invention defined in claim 17, wherein said partitions are removable.

20. The invention defined in claim 17, wherein said partitions are formed as an integral part of said main body.

21. The invention as defined in claim 17 wherein said hinge is comprised of a first section integral with said vent cap and a second section integral with the cover of said battery.

22. The invention as defined in claim 21 wherein the first section of said hinge includes a protuberance and the second section of said hinge includes a detent for hingedly receiving the protuberances of the second section of said hinge.
